(19) United States
(12) Patent Application Publication
(10) Pub. No.: US 2003/0113455 A1
(43) Pub. Date: Jun. 19, 2003

(54) Apparatus and method for controlling the curling or paper or paperboard

(76) Inventors: Stefan Kuni, Jarvenpaa (FI); Mika Leino, Simpele (FI)

Correspondence Address: STEINBERG & RASKIN, P.C., 1140 AVENUE OF THE AMERICAS, 15th FLOOR, NEW YORK, NY, 10036-5803, US

(21) Appl. No.: 10/203,872

(22) PCT Filed: Feb. 15, 2001
(86) PCT No.: PCT/FI01/00134

(30) Foreign Application Priority Data
Feb. 15, 2000 (FI) 20000319

(51) Int. Cl. B05D 3/12; B05D 1/02

(52) U.S. Cl. 427/355; 427/421; 118/100; 118/110; 118/123; 118/300

(57) ABSTRACT

The apparatus for controlling the curling of paper or paperboard comprises members for bringing liquid on a paper or paperboard web (W) and members for spreading the amount of liquid evenly, in such a manner that the members for bringing liquid on the paper or paperboard web (W) are in the travel direction of the web placed before the members for spreading the amount of liquid evenly. The invention also relates to a method for controlling the curling of paper or paperboard.

The present invention relates to an apparatus and method for controlling the curling of paper or paperboard. The term curling refers to the bending of a paper or paperboard web in such a manner that when the web is positioned on the horizontal plane, it bends upwards or downwards towards its edges in comparison with the centre of the web in the width direction. In further processing of paper or paperboard it is necessary that the web is straight or slightly curled on the backside. The curling of paper or paperboard poses a problem especially when only one side of the paper or paperboard web becomes wet, for example in connection with one-side coating of the web. Thus, the web only swells from the other side, and this causes the curling of the web.

A known device and method for controlling the curling of coated paper is disclosed for example in the publication U.S. Pat. No. 4,853,255. The device is composed of two superimposed kiss rolls, between which a nip is formed. The lower roll is partly sunk in a water basin, from which it receives water on its surface while rotating. Excess water is pressed out in the nip, and the rest of the water is conveyed to the surface of the web on the surface of the upper roll, the travel direction of the web being opposite to the direction of rotation of the roll. Thus, the web strokes the water on the surface of the roll therebelow on the surface of its own. The difference between the speed of rotation of the web and the roll is in the order of 1000 m/min.

Generally, in paperboard machines curling is controlled by adjusting the steam system of the cylinder dryer section in such a manner that the temperatures of the upper and lower cylinder groups differ from each other. Thus, the web dries asymmetrically on the upper and lower side, wherein it is possible to affect the curling of the web in this way.

In known methods, problems occur in the adjustment of the amount of water used for straightening the paper or paperboard. Too large an amount of water impairs the moisture profiles of paper or paperboard, requires a large drying capacity and considerably increases the need for drying energy. On the other hand, by means of too small a water amount it is not possible to straighten the paper or paperboard.

If said adjustment of the steam system in the cylinder dryer section is used for controlling the curling, the adjustment affects the entire drying process and reduces the possibilities of making the adjustments necessary in drying.

In the device and method according to the invention the amount of water used for straightening is small, but still sufficient to straighten the paper or paperboard. Thus, the problems occurring in connection with the aforementioned known methods are reduced. The device according to the invention is characterized in that it comprises members for bringing liquid on a paper or paperboard web and members for spreading the amount of liquid evenly, in such a manner that the members for bringing liquid on the paper or paperboard web are in the travel direction of the web placed before the members for spreading the amount of liquid evenly. The method according to the invention is characterized in that liquid is brought on the paper or paperboard and the amount of liquid is spread out evenly. The method according to the invention for renewing a coating line is characterized in that an assembly is installed in the coating line, which comprises members for bringing liquid on the paper or paperboard and members for spreading the amount of liquid evenly.

By means of the device and method according to the invention the amount of water can be adjusted so that it becomes suitable, and the liquid can be spread evenly on the web. Thus, in addition to a uniform result, advantages are also attained by the minimization of the use of liquid and small energy consumption. The moistening by means of liquid, typically water, can advantageously be conducted in a conventional coating station, although the invention can also be applied outside the coating station. Curling can be eliminated in the web by treating one side of the web while the other side is coated, or in a separate process, wherein the dried paper or paperboard is moistened with liquid to control curling. The apparatus and method according to the invention are most often used to straighten paper or paperboard, especially paperboard, that has curled in connection with the coating process, but the aforementioned apparatus and device are suitable for all curling control of the web irrespective of the reason for curling. The grammage of the paperboards to be straightened is usually between 100 to 400 g/m². The apparatus has a relatively simple structure. The members for bringing liquid on the paper or paperboard web can be removed, or set to an inactive state when they are not required.

In the device according to the invention, the members for bringing liquid on the paper or paperboard web comprise a liquid source, members for conveying the liquid and at least one inlet opening for the liquid. The liquid source can be for example a water distribution system or a liquid container. The members for conveying liquid comprise at least one pipe or the like, along which liquid is arranged to flow the distance between the liquid source and the inlet opening for the liquid. The members for conveying liquid may also include a pump or a corresponding device, which is arranged to convey liquid towards the inlet opening for the liquid.

Typically, there are several inlet openings for the liquid, because they must be capable of bringing liquid on the paper or paperboard web, substantially on the entire width of the web. The inlet openings for the liquid may be located at fixed intervals on the periphery of the pipe intended for conveying liquid, in the longitudinal direction of the pipe in such a manner that the inlet openings are directed in a suitable manner to bring liquid on the paper or paperboard web. The inlet opening for the liquid can be for example a hole in a nozzle intended for spraying liquid media, from which hole liquid is sprayed on the web in the form of conical or fan-shaped jets at a suitable pressure and flow rate. To convey liquid to the inlet openings for the liquid it is advantageous to use an arrangement comprising a pipe to which nozzles or the like are arranged at fixed intervals.

The members for spreading the amount of liquid evenly comprise a doctor which can be for example a doctor blade, a rod doctor, or a roll nip. The paper or paperboard web is arranged to travel via the doctor to remove excess liquid from the section of the web that has travelled via the doctor. After the doctor there is a sufficient amount of liquid on the paper or paperboard web to control the curling of the web, the liquid being spread evenly on the entire web. In order to prevent stripes caused by liquid from being generated on the web and/or uneven spreading of liquid on the surface of the web, it is advantageous that an excess amount of liquid is applied on the web in such a manner that back flow from the doctor takes place. Different coating stations and doctors related to the same are of prior art known in the field of coating techniques, and thus they will not be described in more detail in this application.

To control the curling of the web, the liquid must be at least partly absorbed in the web. The absorption time of the liquid can be adjusted by adjusting the distance between the point which liquid is brought on the web by the members for conveying liquid on the web and the members for spreading the liquid evenly. This distance is dependent on the degree of straightening required in the curled web, and the distance is typically 0 to 3000 mm, advantageously 0 to 500 mm.

Generally, the liquid applied on the web from the inlet openings for the liquid is water, but other substantially liquid media are also possible. For example surface sizing media, such as starch, and/or various auxiliary media may be mixed in the liquid. The mixed medium may be in any form in the liquid, it can, for example be dissolved in the liquid or it can form dispersion with the liquid. By means of the substances mixed in the liquid it is for example possible to affect the linting or hydrophobicity of paper or paperboard.

In the following, the apparatus and method according to the invention will be described with reference to the appended drawings, in which

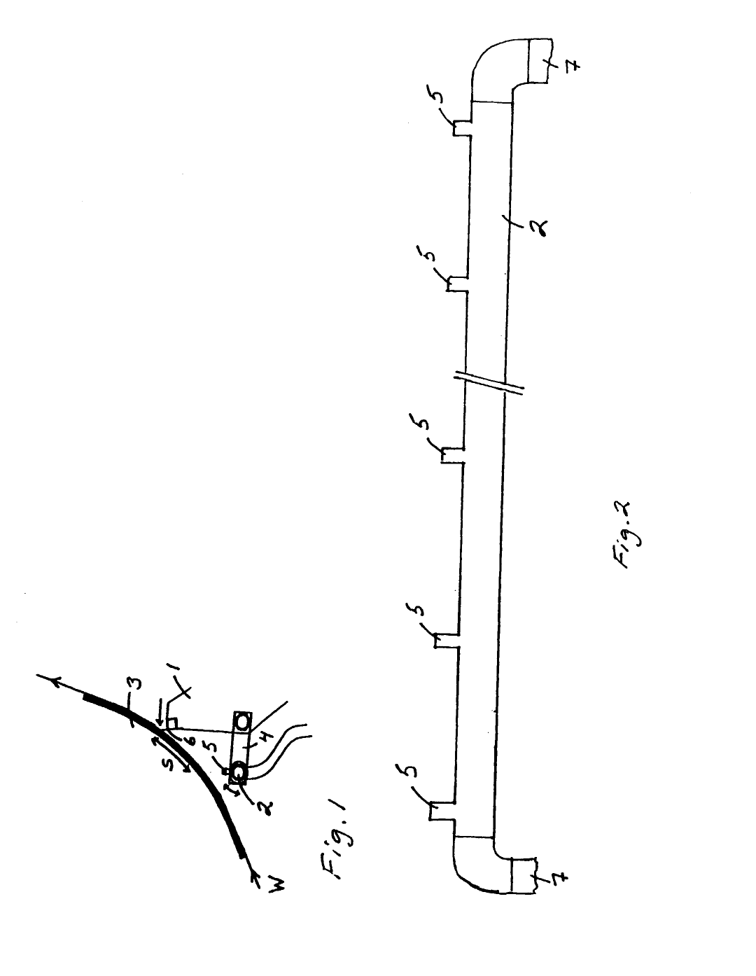

FIG. 1 shows the principle of the device according to the invention in a side view,

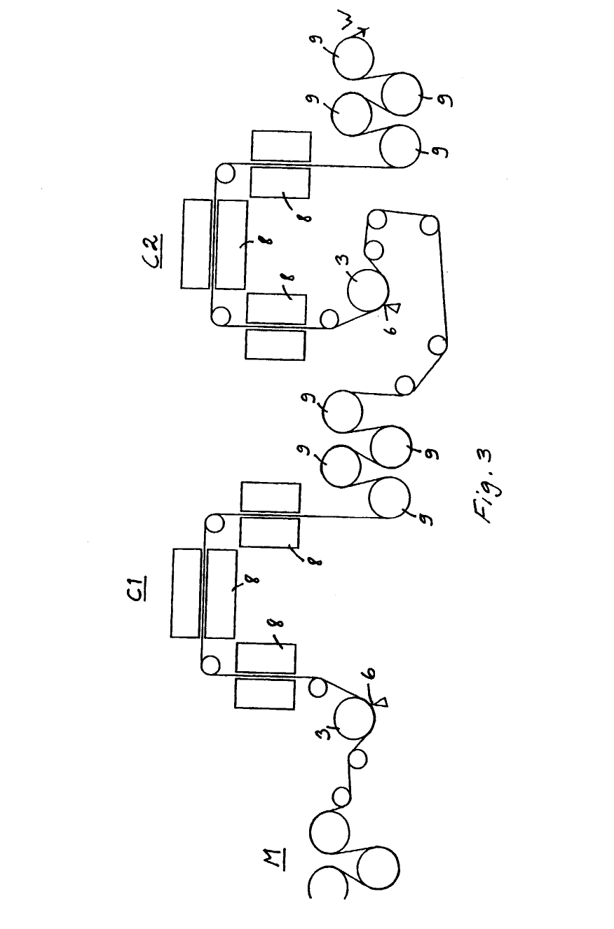

FIG. 2 shows a part of a pipe intended for conveying liquid in a side view,

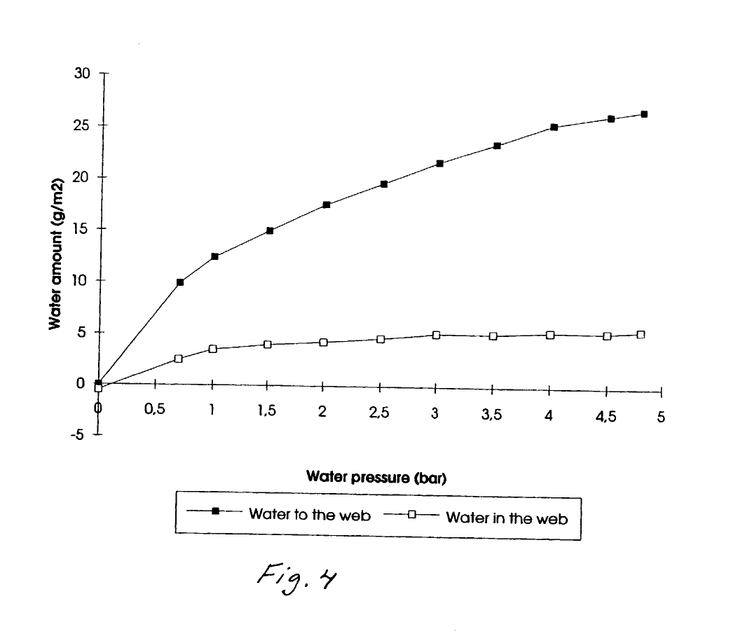

FIG. 3 shows schematically a coating line, in which the invention can be used,

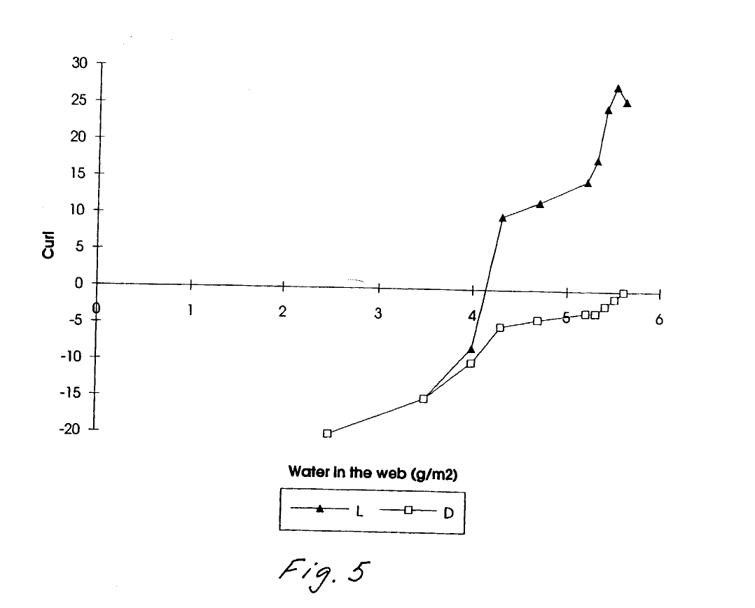

FIG. 4 is a diagram illustrating the amount of water sprayed on paperboard D, and the amount of water measured from the paperboard D as a function of water pressure,

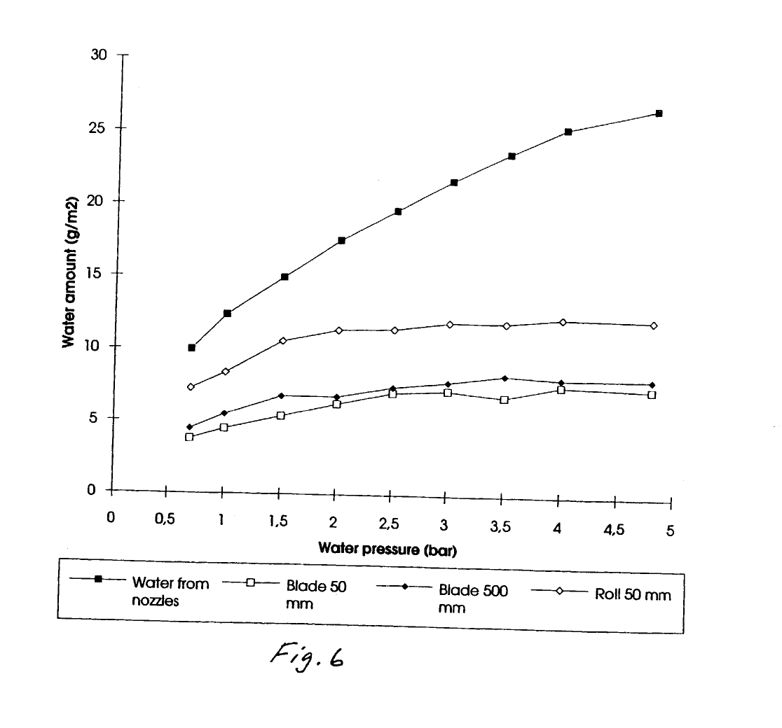

FIG. 5 is a diagram illustrating the curling of paperboard L and paperboard D as a function of the amount of water in said paper and paperboard webs,

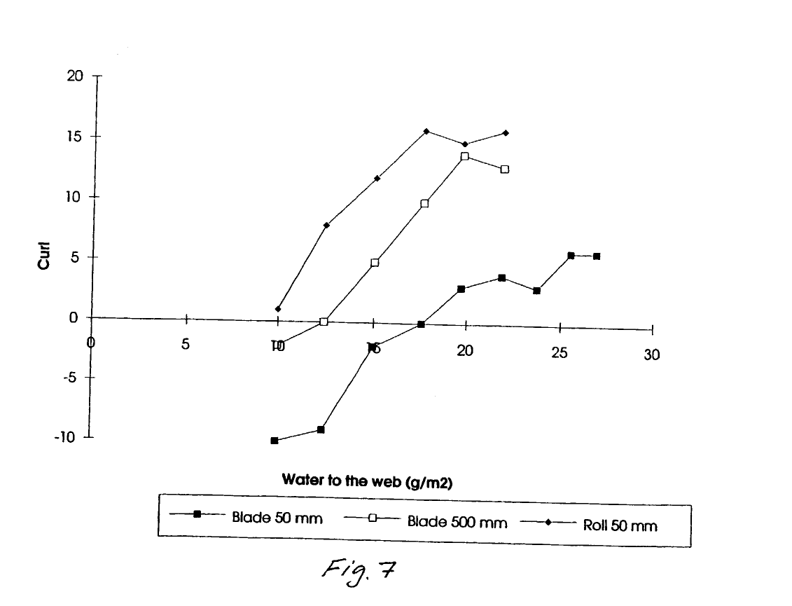

FIG. 6 is a diagram of the amount of water after various treatments as a function of water pressure,

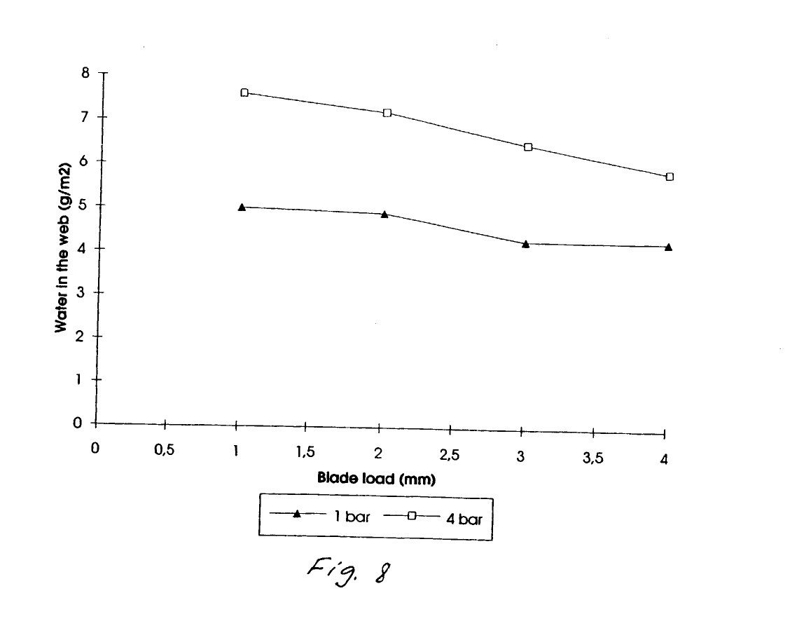

FIG. 7 is a diagram illustrating the curling as a function of the amount of water sprayed from the nozzles,

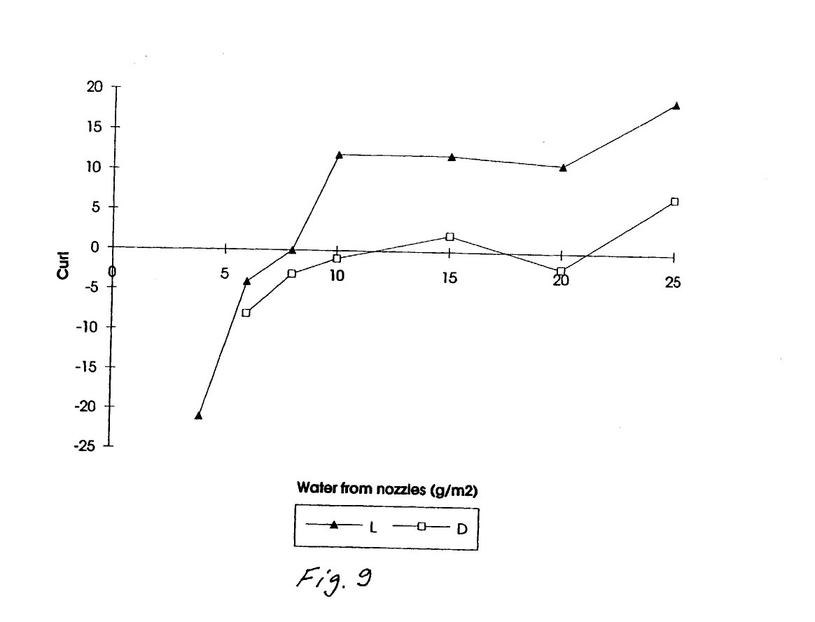

FIG. 8 is a diagram illustrating the effect of the loading of the blade on the amount of water measured from the paperboard,

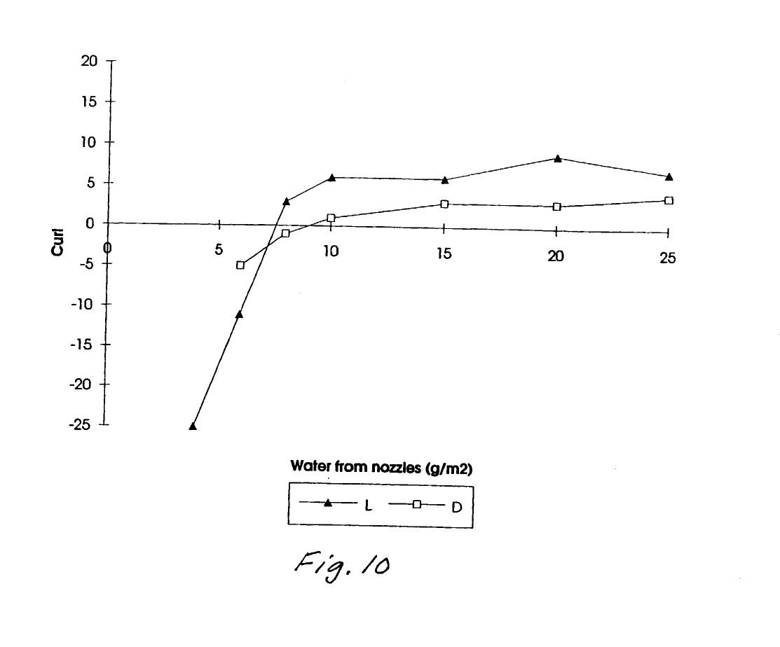

FIG. 9 is a diagram illustrating the curling of paperboard L and paperboard D as a function of the amount of water sprayed from the nozzles, when a doctor blade is not used, and

FIG. 10 is a diagram illustrating the curling of paperboard L and paperboard D as a function of the amount of water sprayed from the nozzles, when a doctor blade is used.

According to FIG. 1, a web W travels on the surface of a counter roll 3. In a blade bearer 1 in the coating station a mounting 4 is fixed, said mounting supporting a pipe 2. Mountings 4 are located on both ends of the pipe 2, and the pipe 2 extends over the entire width of the web W. Both ends of the pipe 2 are closed in a pressure-tight manner.

The pipe 2 has nozzles 5, which are arranged to spray liquid on the web W. The liquid is sprayed on the web W in such a manner that it reaches the web within a distance s from the doctor blade 6. The distance s is approximately 50 to 500 mm, advantageously 50 to 200 mm. The distance s depends for example on the paper or paperboard grade and on its capability to absorb water. The distance s must be selected by taking into account both the factors resulting from the paper or paperboard grade, such as the absorption capacity of the web and the running speed of the machine. The distance s can be adjusted to attain the desired effect of preventing the curling, for example by rotating the pipe 2 around its longitudinal axis. The doctor blade 6, which extends over the entire width of the web, spreads the liquid evenly on the entire web W, removes excess water and helps in the absorption of water to the web W, especially in connection with hydrophobic materials. The amount of water remaining on the web W depends on the blade angle of the doctor blade 6 and on the pressure with which it is pressed against the web W and the counter roll 3. The position of the doctor blade 6 is changed for example in such a manner that the mounting structure of the doctor blade 6 has a pneumatic hose, by means of which the doctor blade 6 is transferred towards the web W or away from the same.

FIG. 2 shows a pipe 2 to which nozzles 5 are fixed at intervals of 100 to 150 mm on the entire width of the web W. The liquid flows from a liquid source along a hose 7 or the like first to a pipe 2 and further to nozzles 5. The nozzles 5 are arranged to spray water in jets of conical or fanlike shape. The nozzles 5 are commercially available nozzles which are suitable for spraying of liquid, as can be seen in the examples hereinbelow.

FIG. 3 shows a coating line in which the invention can be used. The paper or paperboard web W is arranged to travel from the production section M of the web to a first coating section C1. The first coating section C1 comprises a coating unit and a drying unit. The coating unit comprises a doctor blade 6 and a counter roll 3. The dryer section comprises dryers 8 and drying cylinders 9.

The paper or paperboard web W is coated from one side and the coating is dried in the first coating section C1. Thereafter the web is guided to a second coating section C2, which comprises a coating unit and a drying unit. The coating unit comprises a doctor blade 6 and a counter roll 3. The dryer section comprises dryers 8 and drying cylinders 9. In both coating sections C1 and C2, the dryers can be for example infrared dryers or air dryers.

In the second coating section C2 liquid, such as water is sprayed on the web W within a suitable distance from the doctor blade (not shown in the drawing). The amount of water is spread evenly by means of the doctor blade 6 and the web W is guided to the dryer section of the second coating section C2. From the second coating section C2 the web for which a desired curling is attained, is guided to further processing, such as reeling.

In the coating line, for example in the coating line according to FIG. 3, it is possible to utilize the parts of the coating line which already exist therein to control the curling of the web. When the web is coated from one side, it is possible to use a coating line used in two-sided coating of the web to control the curling of the web, by means of which liquid is applied on the web in the coating unit on the other side of the web, said liquid being spread evenly by means of a doctor blade or a corresponding doctor. The liquid can be supplied via an apparatus generally intended for the supply of coating colour, or via a separate apparatus, for example an apparatus similar to the one shown in FIG. 2.

It is also possible add a counter roll in the end of the coating section or the coating machine, or an already used leading roll can be used as a counter roll. The coating line can also be supplemented with the members necessary for bringing liquid on the web and spreading the amount of liquid evenly.

In the following, the invention will be described by means of examples.

In experiments according to the examples, a method is used for curling tests in which A3-sized sheets were cut from the webs in such a manner that the longer edge of the sheet is parallel to the longitudinal direction of the web. From the middle of the A3 sheets test samples of 15×150 mm were cut, said samples being parallel to the shorter edge of the sheet, i.e. the width direction of the web. The test samples were attached to jaws from their upper ends in such a manner that the shorter edge of the sample was parallel to the horizontal plane. The topside of the sample is positioned on the left-hand side when seen from the front. The samples were allowed to hang freely for 20 minutes, whereafter the curling was measured.

In the measuring device there is a curling scale at the location of the lower edge of the sample, in which the − scale is on the left-hand side and the + scale is on the right-hand side. If the sample is curled to the top, the curling is marked with a minus sign. In samples which are curled to the backside, the curling is marked with a plus sign. For certain grades, which are used as test material in the following examples, a good result is if the curling is in the order of 0 to +20. The value 0 indicates a straight sample and the value +20 a sample which is slightly curled to the backside.

In the experiments according to the examples, two different paperboard grades were used as test material, which will be referred to as paperboard D and paperboard L hereinbelow. The paperboards are surfacesized paperboards, double coated on one side, which were not wetted from the other side in connection with the coating process. The grammage of the paperboard D was 193 g/m². Both the paperboard D and the paperboard L were strongly curled towards the topside before the experiment.

In the testing equipment according to the examples, the pressure of water could be measured and adjusted. Before the point of measuring the water pressure there was an adjustment member, by means of which it was possible to adjust the pressure of the water flowing towards the web. By adjusting the pressure of water it was possible to affect the amount of water to be sprayed.

### EXAMPLE 1

Paperboard D and paperboard L were used as test material.

To spray water on the web, nozzles intended for spraying of liquid were used (Veejet H-VVL, Spraying Systems Co., USA). The nozzles were installed in a pipe located in the width direction of the paperboard web according to FIG. 3. The nozzles were located within a distance of 130 mm from each other. The nozzles were followed by a doctor blade whose length was 840 mm, thickness 0.457 mm and the acute angle 25°. The distance between the point in which the liquid coming from the nozzles hit the web and the doctor blade was 50 mm.

At first, it was tested how much water remains in the paperboard D when a certain amount of water is sprayed on the surface of the same. The purpose was to make a calibration curve, which would show the pressure at which the spraying of water must be conducted so that a certain amount of water remains in the material to be moistened after the doctor blade treatment. The results are shown in Table 1 and graphically in FIG. 4.

TABLE 1
Pressure of sprayed water, corresponding amount of water
and the amount of water measured from the paperboard D.

| | | | Water amount |
|---|---|---|---|
| | Water | Sprayed water | (g/m²) measured |
| Test point | pressure (bar) | amount (g/m²) | from the paperboard D |
| 1 | 0.7 | 9.9 | 2.5 |
| 2 | 1.0 | 12.4 | 3.5 |
| 3 | 1.5 | 15.0 | 4.0 |
| 4 | 2.0 | 17.6 | 4.3 |
| 5 | 2.5 | 19.7 | 4.7 |
| 6 | 3.0 | 21.8 | 5.2 |
| 7 | 3.5 | 23.6 | 5.2 |
| 8 | 4.0 | 25.5 | 5.4 |
| 9 | 4.5 | 26.4 | 5.4 |
| 10 | 4.8 | 26.9 | 5.6 |
| 11 | 0 | 0 | −0.5 |

The results show that the amount of water measured from the paperboard slowly increased when compared to the amount of water sprayed on the paperboard D, in other words, the equalizing effect of the doctor blade can be clearly seen in the test results. With smaller amounts of water the amount of water measured from the paperboard increased more rapidly, but was equalized when the amount of water was increased. The negative value measured by the sample 11 is explained by drying of the sample when compared to the initial state during the experiment.

Thereafter the paperboard D and the paperboard L were run, said paperboards being dried by means of an air dryer at the speed of 500 m/min. The purpose was to dry the aforementioned materials in such a manner that their humidity would be the same as in the unwinding. Thereafter the curling of both paperboard grades was measured by means of the above-described method. The curling results are shown in Table 2 and graphically in FIG. 5.

TABLE 2
Curling of paperboard D and paperboard L as a function
of the water amount measured from the paperboard.

| Water amount (g/m²)*⁾ | Curling of | Curling of |
|---|---|---|
| in the web | paperboard L | paperboard D |
| 2.5 | −20 | −20 |
| 3.5 | −15 | −15 |
| 4.0 | −8 | −10 |
| 4.3 | 10 | −5 |
| 4.7 | 12 | −4 |
| 5.2 | 15 | −3 |
| 5.3 | 18 | −3 |
| 5.4 | 25 | −2 |
| 5.5 | 28 | −1 |
| 5.6 | 26 | 0 |

*⁾The amount of water estimated according to Table 1.

The amount of water estimated according to Table 1. The results show that it was more difficult to straighten the paperboard D than the paperboard L. The paperboard D requires a longer absorption time, which can be arranged for example by increasing the distance between the point where the water sprayed from the nozzles hits the web and the doctor blade. For the paperboard L, the used distance was sufficient with amounts of water exceeding 4.0 g/m², and the results obtained in this grade were good.

### EXAMPLE 2

Paperboard D was used as test material.

In the pipe nozzles (Veejet 11003, Spraying Systems Co., USA) were installed in such a manner that five nozzles were placed next to each other, and the distance between the nozzles was 130 mm.

In the experiment, different members were used to spread out the liquid evenly. In the experiment, both a doctor blade and a doctor roll were used. For the sake of comparison the amount of water was also measured when water was only sprayed on the web without spreading it out evenly.

The doctor blade was 840 mm long and 0.457 mm thick, and its acute angle was 25°. The distance between the point in which the water coming from the nozzles hits the web and the doctor blade was adjusted so that two distances were used, which were 50 and 500 mm.

The sprayed amount of water was determined on the basis of water pressure, as in the example 1. Table 3 and FIG. 6 show the amount of water measured from the paperboard as a function of pressure.

TABLE 3
Water pressure, sprayed amount of water corresponding to the
pressure and the amount of water measured from the paperboard
when different members are used for spreading the liquid evenly.

| | | Water amount | Water amount | Water amount |
|---|---|---|---|---|
| | Sprayed | (g/m²)**⁾ | (g/m²) | (g/m²) |
| Water | water | measured from | measured from the | measured from |
| pressure | amount | the paperboard | paperboard after | the paperboard |
| (bar) | (g/m²) | after the blade | the blade***⁾ | after the roll**⁾ |
| 0.7 | 10 | 3.8 | 4.5 | 7.3 |
| 1 | 12.4 | 4.5 | 5.5 | 8.4 |
| 1.5 | 15 | 5.4 | 6.8 | 10.6 |
| 2 | 17.6 | 6.3 | 6.8 | 11.4 |
| 2.5 | 19.7 | 7.1 | 7.5 | 11.5 |
| 3 | 21.8 | 7.3 | 7.9 | 12 |
| 3.5 | 23.7 | 6.9 | 8.4 | 12 |
| 4 | 25.5 | 7.7 | 8.2 | 12.4 |
| 4.8 | 26.9 | 7.5 | 8.2 | 12.3 |

**⁾the distance between the doctor and the nozzles is 50 mm
***⁾the distance between the doctor and the nozzles is 500 mm

The results show that the use of the blade keeps the water amounts measured from the paperboard on a suitably low level, even though the amount of water sprayed from the nozzles varies. When the distance of the blade from the point where the liquid coming from the nozzles hits the web is longer (500 mm), the water amount measured from the paperboard is larger than in the short distance (50 mm). When the doctor roll is used, the amount of water is larger than when the doctor blade is used, but the measured water amounts remain relatively well on the same level irrespective of the sprayed amount of water. The water amount increases steadily when doctors are not used.

The paperboards which were treated in the manner shown in Table 3 were subjected to curling measurement. Table 4 and FIG. 7 show the curling of paperboard as a function of the water amount sprayed on the web.

TABLE 4
Water pressure, sprayed amount of water corresponding to
the pressure and curling measured from the paperboard when
different members are used for spreading the liquid evenly.

| | | Curling of | Curling of | Curling of |
|---|---|---|---|---|
| | Sprayed | the paper- | the paper- | the paper- |
| Water | water | board when | board when | board when |
| pressure | amount | a blade**⁾ | a blade***⁾ | a roll**⁾ |
| (bar) | (g/m²) | is used | is used | is used |
| 0.7 | 10 | −10 | −2 | 1 |
| 1 | 12.4 | −9 | 0 | 8 |
| 1.5 | 15 | −2 | 5 | 12 |
| 2 | 17.6 | 0 | 10 | 16 |
| 2.5 | 19.7 | 3 | 14 | 15 |
| 3 | 21.8 | 4 | 13 | 16 |
| 3.5 | 23.7 | 3 | — | — |
| 4 | 25.5 | 6 | — | — |
| 4.8 | 26.9 | 6 | — | — |

**⁾the distance between the doctor and the nozzles is 50 mm
***⁾the distance between the doctor and the nozzles is 500 mm

The advantage of using a doctor roll instead of a doctor blade is that the roll does not lift fibres from the material to be scraped, which may sometimes take place when the doctor blade is used. The doctor blade straightens the paper or paperboard with smaller amounts of water when compared to a doctor roll, which is advantageous in view of drying.

### EXAMPLE 3

Paperboard D was used as test material.

The effect of the loading of the doctor blade was measured by loading the doctor blade with four different loadings. Water was sprayed on the web in such a manner that the water pressure was 1.0 bar and 4.0 bar. The effect of the loading of the blade is shown in Table 5 and in FIG. 8.

TABLE 5
Effect of the loading of the doctor blade to the amount of water
measured from the paperboard at two different water pressures.

| | Water amount (g/m²) | Water amount (g/m²) |
|---|---|---|
| | measured from the | measured from the |
| Loading of the | paperboard when water | paperboard when water |
| doctor blade (mm) | pressure = 1.0 bar | pressure = 4.0 bar |
| 1.0 | 5.0 | 7.6 |
| 2.0 | 4.9 | 7.2 |
| 3.0 | 4.3 | 6.5 |
| 4.0 | 4.3 | 5.9 |

The results show that the amount of water measured from the paperboard slowly decreased when loading of the blade was increased, although when the amount of water sprayed on the paperboard is small, the amount of water measured from the paperboard after the doctor blade seems to reach a certain minimum value.

### EXAMPLE 4

Paperboard D and paperboard L were used as test material.

In the pipe two rows of nozzles (SU12, Spraying Systems Co., USA) were installed, the distance between the nozzles being 2.5 mm.

The doctor blade was a blade whose length was 840 mm and thickness 0.457 mm, and the acute angle was 90°. The loading of the blade was 4.0 mm, and the angle between the blade and the tangent of its counter blade was 7°.

At first, water was sprayed on the web, whereafter a doctor was not used. In a second experiment, water was first sprayed on the web, whereafter a doctor blade was used.

The water amount in the materials was determined from the moist samples. The dried webs were subjected to curling measurement by means of the above-described method. The results are shown in Tables 6 and 7, FIGS. 9 and 10 providing the corresponding graphical representations.

TABLE 6
Water amounts measured from paperboard D
and paperboard L, when a doctor was not used.

| Sprayed | Water amount | Water amount | | |
|---|---|---|---|---|
| water | (g/m²) | (g/m²) | | |
| amount | measured from | measured from | Curling of | Curling of |
| (g/m²) | paperboard L | paperboard D | paperboard L | paperboard D |
| 4 | 4.6 | | −21 | |
| 6 | 8.4 | 8.3 | −4 | −8 |
| 8 | 11.5 | 10.5 | 0 | −3 |
| 10 | 14.0 | 11.1 | 12 | −1 |
| 15 | 16.0 | 13.8 | 12 | 2 |
| 20 | 17.5 | 15.4 | 11 | −2 |
| 25 | 20.0 | 19.4 | 19 | 7 |

TABLE 7
Water amounts measured from paperboard D
and paperboard L, when a doctor was used.

| Sprayed | Water amount | Water amount | | |
|---|---|---|---|---|
| water | (g/m²) | (g/m²) | | |
| amount | measured from | measured from | Curling of | Curling of |
| (g/m²) | paperboard L | paperboard D | paperboard L | paperboard D |
| 4 | | | −25 | |
| 6 | 6.4 | | −11 | −5 |
| 8 | 7.8 | 6.0 | 3 | −1 |
| 10 | 7.1 | 6.0 | 6 | 1 |
| 15 | 7.3 | 6.1 | 6 | 3 |
| 20 | 7.3 | 6.3 | 9 | 3 |
| 25 | 7.8 | 6.8 | 7 | 4 |

The results in Table 6 and FIG. 9 show that when water was sprayed from the nozzles and the doctor was not used, small amounts of water did not straighten the paperboard D and paperboard L sufficiently, but the aforementioned materials remained curled towards the topside. The water amount required in the straightening was 10 to 15 g/m². After the wetting, the web contained streaks of water, and the occurrence of mist also posed a problem when water was sprayed from the nozzles.

The results in Table 7 and in FIG. 10 show that when a doctor blade was used after moistening. a more uniform result was obtained. There were no streaks of water if the water amount was suitable. If the water amount was too small, streaks occurred. On the basis of the results, an excess amount of water must be applied on the web so that it is possible to remove water by means of the blade to attain a uniform result. Such an amount is 6 to 8 g/m². Both grades were straightened with a water amount below 10 g/m².

The examples do not restrict the invention, but the invention may vary within the scope of the claims. The members for bringing water on the paper or paperboard web do not necessarily have to be composed of a pipe equipped with nozzles, but they can be for example special moistening devices or the liquid can be applied on the web via members intended for supplying coating colour in the coating station.

1. An apparatus for controlling curling of paper or paperboard, characterized in that it comprises members for bringing liquid on a paper or paperboard web (W) and members for spreading the amount of liquid evenly, in such a manner that the members for bringing liquid on the paper or paperboard web (W) are in the travel direction of the web placed before the members for spreading the amount of liquid evenly.

2. The apparatus according to claim 2, characterized in that the members for bringing liquid to the paper or paperboard web (W) comprise one or more inlet openings for liquid.

3. The apparatus according to claim 2, characterized in that the inlet openings for liquid are arranged to bring liquid on the entire width of the paper or paperboard web (W).

4. The apparatus according to claim 2 or 3, characterized in that the inlet opening for the liquid is a hole in a nozzle (5).

5. The apparatus according to claim 4, characterized in that the nozzle (5) is arranged to spray liquid, especially water or aqueous liquid, on the paper or paperboard web (W).

6. The apparatus according to claim 1, characterized in that members for spreading the amount of liquid evenly comprise a doctor placed within a fixed distance (s) from the point of spraying liquid.

7. The apparatus according to claim 6, characterized in that the doctor is a doctor blade (6).

8. The apparatus according to claim 6, characterized in that the doctor is a rod doctor.

9. The apparatus according to claim 6, characterized in that the doctor is a roll nip.

10. A method for controlling the curling of paper or paperboard, characterized in that liquid is applied on paper or paperboard web, and the amount of liquid is spread evenly.

11. The method according to claim 10, characterized in that liquid is applied on the paper or paperboard web (W) 0 to 3000 mm, advantageously 0 to 500 mm before it is spread out.

12. The method according to claim 10, characterized in that the liquid is brought on the web (W) by means of members for bringing liquid on the paper or paperboard web.

13. The method according to claims 10 to 12, characterized in that the members for bringing liquid on the paper or paperboard web comprise inlet openings for liquid, and the liquid is sprayed on the web (W) through the inlet openings for liquid.

14. The method according to claim 10, characterized in that the amount of water brought on the web (W) is spread out by means of members for spreading the amount of liquid evenly.

15. The method according to claim 14, characterized in that the amount of water is spread out in such a manner that excess liquid is removed by means of the members for spreading the amount of liquid evenly.

16. A method for renewing the coating line for paper or paperboard web (W) in such a manner that the curling of a paper or paperboard web can be controlled in the coating line, characterized in that an assembly is installed in the coating line, which comprises members for bringing liquid on the paper or paperboard and members for spreading the amount of liquid evenly.

17. The method according to claim 16, characterized in that the assembly installed in the coating line utilizes the parts already existing in the coating line.

18. The method according to claim 17, characterized in that in the assembly a supply equipment of coating colour is used as a member for bringing liquid on the paper or paperboard web.

19. The method according to claim 17 or 18, characterized in that in the assembly the roll located in the coating line is used as a counter roll for the members for spreading the liquid evenly.

20. The method according to any of the preceding claims 17 to 19, characterized in that the doctor of the coating unit is used as a member or spreading the amount of liquid evenly.
